(19) United States
(12) Patent Application Publication
(10) Pub. No.: US 2009/0115639 A1
(43) Pub. Date: May 7, 2009

(54) METHOD AND SYSTEM FOR INDICATING A LOCATION OF A VEHICLE

(75) Inventors: David T. Proefke, Madison Heights, MI (US); Clark E. McCALL, Ann Arbor, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/935,123

(22) Filed: Nov. 5, 2007

(51) Int. Cl. G08G 1/123

(52) U.S. Cl. 340/989

(57) ABSTRACT

Methods and systems for indicating the location of a vehicle to a user are provided. An alert is generated with a device onboard the vehicle when a distance between an electronic device and the vehicle is less than a predetermined distance. A property of the alert is varied to indicate the location of the vehicle to the user.

### TECHNICAL FIELD

The present invention generally relates to vehicles, such as automobiles, and more particularly relates to a method and system for indicating the location of a vehicle to a user.

### BACKGROUND OF THE INVENTION

In recent years, advances in technology, as well as ever-evolving tastes in style, have led to substantial changes in the design of automobiles. One of the changes involves the variety and complexity of the luxury and convenience features now found as standard equipment on many automobiles, such as the inclusion of small electronic devices that are often connected to (or integral with) the keys to the automobile or a keychain. These devices are often referred to as “key fobs” or “key fob transmitters.”

Key fobs typically provide various remote control functions such as locking and unlocking the doors, opening the trunk, and starting the engine. Key fobs may also provide a button (e.g., a “panic” button) that activates the horn, or other audio device, to assist the user when searching for his or her vehicle. However, when the user is relatively far from the vehicle, or when the vehicle is in a noisy environment, the audible signals provided by conventional systems are insufficient to permit the user to find his or her vehicle.

Accordingly, it is desirable to provide a method and a system for indicating the location of a vehicle to a user using distinctive audible and/or visible signals. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A method for indicating the location of a vehicle to a user is provided. An alert is generated with a device onboard the vehicle when a distance between an electronic device and the vehicle is less than a predetermined distance. A property of the alert is varied to indicate the location of the vehicle to the user.

A method for indicating a location of an automobile to a user is provided. A signal having an associated signal characteristic is received. The signal characteristic is representative of a duration of actuation of an input mechanism on the electronic device. An alert is generated with a device onboard the automobile in response to the receiving the signal to indicate to the user the location of the automobile. The alert is at least one of an audible alert and a visible alert and has a property. The property of the alert is varied based on the signal characteristic.

An automotive annunciation system is provided. The automotive annunciation system includes an annunciation device and a processor in operable communication with the annunciation device. The processor is configured to receive a signal having an associated signal characteristic, generate an alert having a property in response to the receiving the signal to indicate to a user the location of the vehicle, and vary the property of the alert based on the signal characteristic.

### DESCRIPTION OF THE DRAWINGS

The present invention will hereinafter be described in conjunction with the following drawing figures, wherein like numerals denote like elements, and

FIG. 1 is a schematic view of an exemplary automobile according to one embodiment of the present invention;

FIG. 2 is plan view of a key fob;

FIG. 3 is a schematic view of the key fob of FIG. 2;

FIG. 4 is a flow chart of a method for indicating the location of a vehicle according to one embodiment of the present invention; and

FIG. 5 is a flow chart of a method for indicating the location of a vehicle according to another embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

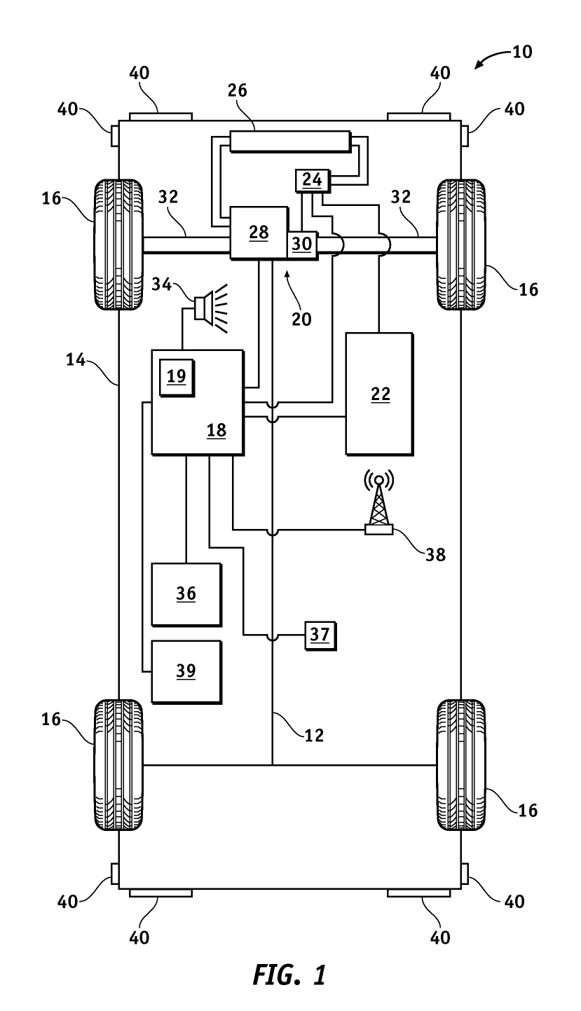

The following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment. It should also be understood that FIGS. 1-5 are merely illustrative and may not be drawn to scale.

FIG. 1 to FIG. 5 illustrate one or more methods and systems for indicating the location of a vehicle to a user. In one embodiment, once a key fob is brought within a predetermined distance of the vehicle, an alert is generated and varied by a device on the vehicle. The variations in the alert are based on the prolonged actuation of a user input mechanism on the fob and/or the location of the fob relative to the vehicle.

FIG. 1 illustrates a vehicle, or automobile, 10 according to one embodiment of the present invention. The automobile 10 includes a chassis 12, a body 14, four wheels 16, and an electronic control system (or electronic control unit (ECU)) 18. The body 14 is arranged on the chassis 12 and substantially encloses the other components of the automobile 10. The body 14 and the chassis 12 may jointly form a frame. The wheels 16 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2 WD) (i.e., rear-wheel drive or front-wheel drive), four-wheel drive (4 WD) or all-wheel drive (AWD). The automobile 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

In the exemplary embodiment illustrated in FIG. 1, the automobile 10 is a hybrid vehicle, and further includes an actuator assembly (or powertrain) 20, a battery 22, a power inverter (or inverter) 24, and a radiator 26. The actuator assembly 20 includes an internal combustion engine 28 and an electric motor/generator (or motor) system (or assembly) 30. Although not illustrated, the power inverter 24 may include a plurality of switches, or transistors, as is commonly understood. The electric motor system 30, in one embodiment, includes one or more sinusoidally-wound, three-phase alternating current (AC) motor/generators (or motors) (e.g., permanent magnet) such as commonly used in automotive vehicles (e.g., traction drive control systems, and the like). As will be appreciated by one skilled in the art, each of the electric motors includes a stator assembly (including conductive coils), a rotor assembly (including a ferromagnetic core), and a cooling fluid (i.e., coolant). The stator assembly and/or the rotor assembly within the electric motors may include multiple (e.g., sixteen) electromagnetic poles, as is commonly understood.

Still referring to FIG. 1, and as described in greater detail below, the combustion engine 28 and the electric motor system 30 are integrated such that both are mechanically coupled to at least some of the wheels 16 through one or more drive shafts 32. The radiator 26 is connected to the frame at an outer portion thereof and although not illustrated in detail, includes multiple cooling channels therethough that contain a cooling fluid (i.e., coolant) such as water and/or ethylene glycol (i.e., “antifreeze) and is coupled to the engine 28 and the inverter 24. The inverter 24 receives and shares coolant with the electric motor 30. The radiator 26 may be similarly connected to the inverter 24 and/or the electric motor 30.

The electronic control system 18 is in operable communication with the actuator assembly 20, the battery 22, and the inverter 24. Although not shown in detail, the electronic control system 18 includes various sensors and automotive control modules, or electronic control units (ECUs), such as a body control module (BCM) 19, and at least one processor and/or a memory which includes instructions stored thereon (or in another computer-readable medium) for carrying out the processes and methods as described below.

The automobile 10 further includes an audio (or audible) device 34, a Global Positioning System (GPS) module 36, a sensor assembly 37, an antenna 38, a navigation database 39, and various lights 40, all of which are connected to the frame (i.e., “onboard” the automobile 10) and in operable communication with the electronic control system 18. The audio device 34 is, for example, a horn or speaker. The GPS module 36 is also in operable communication with multiple GPS satellites in orbit around the Earth, and may include a processor and a separate antenna to communicate with the satellites to determine the location of the automobile 10. The sensor assembly 37 may include one or more sensors, such as a microphone and a camera, to detect ambient conditions around the automobile 10, such as an ambient noise level.

The antenna 38 is a transducer designed to transmit and/or receive electromagnetic waves (e.g., radio waves) in the well-known manner. The navigation database includes navigation-related data such as maps, locations of landmarks and data related to different areas such as restricted noise areas.

The lights (or lamps) 40 are positioned on an outer portion of the body 14, and although not shown as such, are in operable communication with the electronic control system 18 (or the BCM 19). The lights 40 may include, for example, head lights on the front of the automobile 10, tail lights on the rear of the automobile 10, and signal lights on lateral sides of the automobile 10.

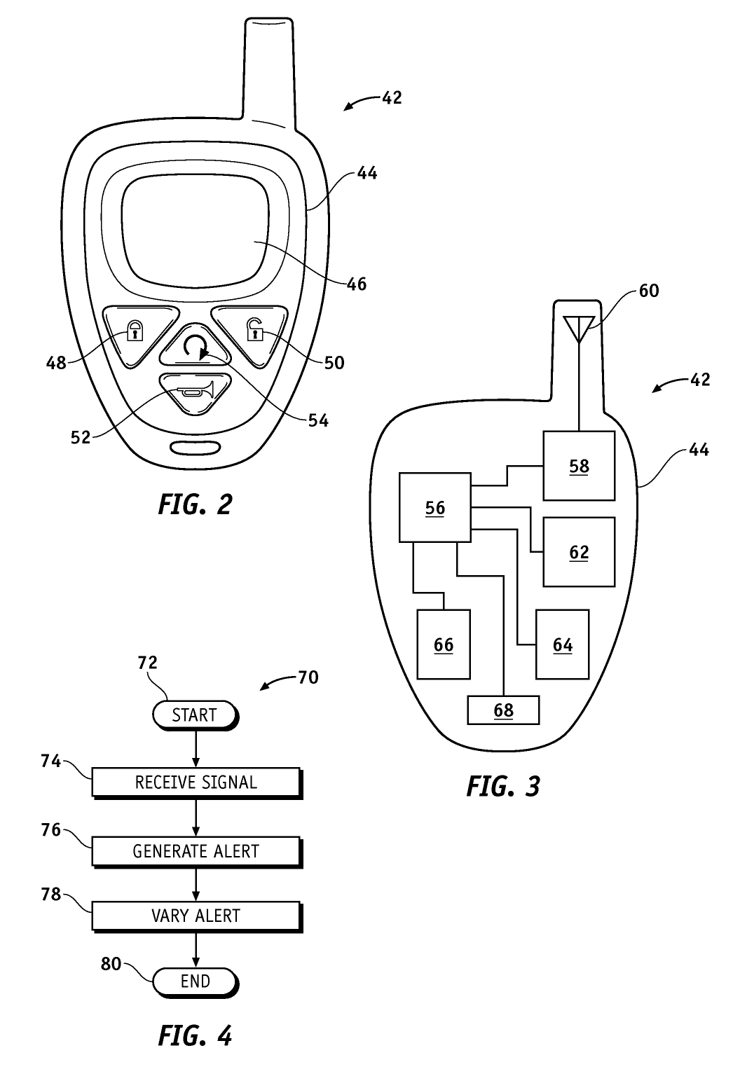

FIGS. 2 and 3 illustrate a key fob (or key fob transmitter) 42. As shown in FIG. 2, the fob 42 includes a housing 44 with a display screen 46 and multiple buttons (or user input mechanisms) thereon, such as door-lock button 48, a door-unlock button 50, a horn (or “panic”) button 52, and a remote start button 54. Referring to FIG. 3, within the housing 44, the fob 42 includes a controller (or processor) 56, a transceiver 58 with an antenna 60, a fob GPS module 62, a user input interface 64, a display screen interface 66, and a battery 68, all of which are in operable communication as shown. The transceiver 58 may include a radio frequency identification (RFID) chip and/or transmitter, as is commonly understood

During operation, still referring to FIG. 1, the automobile 10 is operated by providing power to the wheels 16 with the combustion engine 28 and the electric motor 30 in an alternating manner and/or with the combustion engine 28 and the electric motor 30 simultaneously. In order to power the electric motor 30, direct current (DC) power is provided from the battery 22 to the inverter 24, which converts the DC power to AC power, prior to energizing the electric motor 30.

According to one embodiment of the present invention, while the automobile 10 is parked, the automobile 10 generates alerts, such as audible and visible signals, based on, for example, a signal received from the fob 42 and/or a distance between the fob 42 and the automobile 10.

FIG. 4 illustrates a method 70 for indicating the location of a vehicle according to one embodiment of the present invention. The method begins at step 72, and at step 74 a signal having an associated characteristic is received. At step 76, an alert is generated in response to the signal, and the alert is varied at step 78. The method 70 may be continuously repeated such that the alert is updated based on changes in the signal characteristic.

In one embodiment, the method 70 is initiated when the fob 42 is brought within range of the automobile 10, and a signal that indicates such is received within the automobile 10. The received signal may be emitted by the transceiver 58 and the antenna 60 within the fob 42 and detected by the antenna 38 within the automobile 10. In the event that the user (e.g., driver) is unable to locate the automobile 10, the user actuates, for example, the horn button 52 on the fob 42, which causes an appropriate signal, or a characteristic associated with the signal already being emitted, to be sent from the fob 42 to the automobile 10, and within the automobile 10, from the antenna 38 to the BCM 19, which results in an alert or signal being generated by the audio device 34 and/or the lights 40.

In one embodiment, the alert is a brief sound (e.g., 25 millisecond (ms)) generated by the audio device 34. The signal sent by the fob 42 and/or the antenna 38 to the BCM 19 includes an indication of how long the horn button 52 has been actuated (i.e., a signal characteristic). The signal characteristic determines how a property of the alert, or a value of a property (e.g., duration and/or intensity), is varied. In the embodiment in which the alert is a brief sound generated by the audio device 34 the duration and/or intensity (i.e., volume) of the alert is increased if the horn button 52 is continuously actuated. For example, if the horn button 52 is actuated and the first alert is a sound with a duration of 25 ms at a first volume level, a second alert with a duration of 50 ms at a second volume level (e.g., louder than the first volume level) is generated by the audio device 34 after the horn button 52 is depressed for 1 second (s).

As a result, if the user is unable to locate his or her vehicle from the first alert, continuous actuation of the horn button 52 on the fob 42 results in increasingly noticeable alerts. Once the user has located the automobile 10, the user may release the horn button 52 to stop the alerts.

In another mode of operation, the method 70 is initiated by the fob 42 being brought within a predetermined distance of the automobile 10, which is determined by the signal strength of the signal emitted by the fob antenna 60 and detected by the antenna 38 and/or the GPS modules 36 and 62, as is commonly understood. When the fob 42 is brought within the predetermined distance (e.g., 20 meters (m)), in an embodiment utilizing the antennas 60 and 38, an appropriate signal is sent from the antenna 38 to the BCM 19, and an alert, similar to those described above, is automatically generated by the audio device 34 and/or the lights 40.

This signal includes an indication of the distance and/or direction between the automobile 10 and the fob 42 (i.e., a signal characteristic). Thus, the properties of the alert are varied based on the distance between the automobile 10 and the fob 42. For example, as the user gets closer to the automobile 10, the alerts may increase in duration or number (i.e., increase from one brief sound to two or more brief sounds). As a result, in situations in which the automobile 10 is not visible by the user, the user is provided with an indication as to whether he or she is getting closer to the automobile 10. If the user successfully locates the automobile 10, the process may be ceased by actuating one of the buttons on the fob 42, such as the horn button 52.

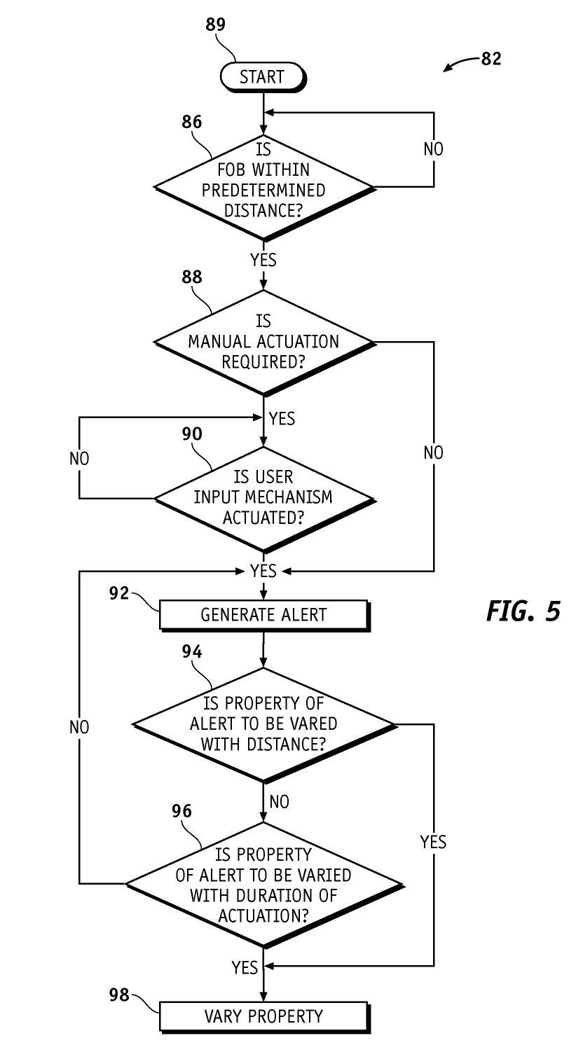

FIG. 5 illustrates a more detailed method 82 for indicating the location of a vehicle. After the method 82 is initiated (e.g., by the automobile 10 being parked), at step 86 it is determined whether or not the fob is within a predetermined distance of the automobile 10. As described above, such a determination may be made by the signal strength of the signal emitted from the antenna 60 within the fob 42 and detected by the antenna 38 within the automobile 10 or using the GPS modules 36 and 62. If not, the method 82 loops back to step 86 until the fob 42 is determined to be within range.

If the fob 42 is within the predetermined distance, at step 88 it is determined whether or not any manual actuation of a user input mechanism on the fob 42 (i.e., pressing one of the buttons on the fob 42) is necessary for the method 82 to continue. If not, the method 82 bypasses step 90 and proceeds to step 92.

If so, step 90 determines whether or not the user mechanism is actuated. If the user mechanism is not actuated, the method 82 loops back to step 90. If the user mechanism is actuated, at step 92 an alert is generated.

Step 94 determines if a property of the alert (e.g., duration and/or intensity) is to be varied based on the distance between the fob 42 and the automobile 10. If not, the method 82 proceeds to step 96. If so, the method 82 bypasses step 96 and the property of the alert is varied at step 98.

Step 96 determines if the property of the alert is to be varied based on the duration of the actuation of the user input mechanism on the fob 42. If not, the method 82 returns to step 92. If so, at step 98, the property is varied.

As described above, at step 96, in an embodiment in which the property of the alert is varied based on the actuation of the user input mechanism on the fob 42, as the duration of actuation increases, the duration and/or intensity increases. In an embodiment in which the property of the alert is varied based on the distance between the fob 42 and the automobile 10, as the distance decreases, the duration and/or intensity increases.

It should be understood that the audible alerts described above may be accompanied by, or even replaced with, visual alerts generated by the lights 40 on the automobile 10. The sensor assembly 37 may be used to adjust the properties of the alerts based on ambient conditions. For example, the volume of the audio alerts may be increased in locations with higher ambient noise levels to increase the likelihood that the alerts are capable of being heard by the user. Additionally, the GPS system may be used in combination with the navigation database 39 to appropriately adjust the properties of the alerts based on the location of the automobile 10 (e.g., reduce the volume of the audio alerts in restricted noise areas). The volume of the audio alerts may also be adjusted based on the time of day (e.g., reduce volume between 12 A.M. and 6 A.M.)

One advantage of the method and system described above is that because the durations and intensities of the alerts and signals generated by the audio device and/or the lights are varied, the distinctiveness of the alerts and signals is improved. As a result, in noisy or crowded situations, or when the user is a far from the vehicle, the efficiency with which he or she is able to find the vehicle is improved. Another advantage is that the method and system described above is that the majority of the components utilized are often already incorporated into automobiles. Therefore, any increase in manufacturing costs is minimized.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for indicating the location of a vehicle to a user comprising:
generating an alert with a device onboard the vehicle when a distance between an electronic device and the vehicle is less than a predetermined distance; and
varying a property of the alert to indicate the location of the vehicle to the user.

2. The method of claim 1, wherein the varying of the property of the alert is based on a duration a user input mechanism on the electronic device is actuated.

3. The method of claim 2, wherein the varying of the property comprises increasing a value of the property as the duration the user input mechanism is actuated increases.

4. The method of claim 1, wherein the varying of the property of the alert is based on a location of an electronic device relative to the vehicle.

5. The method of claim 4, wherein the varying of the property of the alert comprises comprising increasing a value of the property as the distance between the vehicle and the electronic device decreases.

6. The method of claim 3, wherein the electronic device is a key fob.

7. The method of claim 6, wherein the alert comprises an audible alert generated by a horn onboard the vehicle.

8. The method of claim 6, wherein the alert further comprises a visible alert generated by a light onboard the vehicle.

9. The method of claim 7, wherein the property of the alert comprises at least one of a duration of the alert and an intensity of the alert.

10. The method of claim 9, further comprising:
detecting an ambient condition proximate the vehicle; and
adjusting the property of the alert based on the ambient condition proximate the vehicle.

11. A method for indicating a location of an automobile to a user comprising:
receiving a signal having an associated signal characteristic being representative of a duration of actuation of an user input mechanism on an electronic device;
generating an alert with a device onboard the automobile to indicate to the user the location of the automobile in response to the receiving the signal, the alert being at least one of an audible alert and a visible alert and having a property; and
varying the property of the alert based on the signal characteristic.

12. The method of claim 11, wherein the property of the alert comprises a duration of the alert.

13. The method of claim 11, wherein the property of the alert comprises an intensity of the alert.

14. The method of claim 11, further comprising adjusting the intensity of the alert based on the time of day.

15. The method of claim 11, further comprising:
detecting an ambient condition proximate the vehicle; and
adjusting the intensity of the alert based on the ambient condition proximate the vehicle.

16. An automotive annunciation system comprising:
an annunciation device; and
a processor in operable communication with the annunciation device and configured to:
receive a signal having an associated signal characteristic;
generate an alert having a property to indicate to the user the location of the vehicle in response to the receiving the signal; and
vary the property of the alert based on the signal characteristic.

17. The automotive annunciation system of claim 16, wherein the annunciation device comprises a horn, the alert is an audible alert, and the property of the alert comprises at least one of a duration of the audible alert and a volume of the audible alert.

18. The automotive annunciation system of claim 17, wherein the associated signal characteristic is representative of a location of an electronic device relative to the automobile.

19. The automotive annunciation system of claim 17, wherein the associated signal characteristic is representative of a duration of actuation of an user input mechanism on an electronic device.

20. The automotive annunciation system of claim 19, wherein the electronic device is a key fob.
